(19) United States
(12) Patent Application Publication
(10) Pub. No.: US 2002/0136331 A1
(43) Pub. Date: Sep. 26, 2002

(54) Method and apparatus for performing channel estimation with a limiting receiver

(76) Inventors: Leif Wilhelmsson, Daby (SE); Robert Kokke, Lund (SE); Anders Wallen, Eslov (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/011,232

(22) Filed: Nov. 15, 2001

Related U.S. Application Data
(60) Provisional application No. 60/263,505, filed on Jan. 24, 2001.

(51) Int. Cl. H04L 27/22

(52) U.S. Cl. 375/329; 375/229

(57) ABSTRACT

Performing channel estimation with a limiting receiver includes performing a first estimation of a first portion of a signal to obtain first parameters of the portion of the signal. The first portion of the signal has predetermined offsets added during transmission. The predetermined offsets are based on the modulation format of a second portion. The first and second portions have different modulation formats. The first portion of the signal is demodulated using the first parameters to recover data symbols. An equalizer is trained using a decision directed technique to obtain equalizer coefficients. The demodulated first portion of the signal is checked to confirm correct demodulation. The second portion of the signal is then demodulated using the equalizer coefficients.

### CROSS-REFERENCE TO RELATED APPLICATIONS

The present application claims priority benefit of provisional U.S. patent application Ser. No. 60/263,505 filed Jan. 24, 2001, the disclosure of which is incorporated herein by reference in its entirety.

### BACKGROUND

This invention relates to digital communications. In particular, it relates to limiting receivers used to receive data that is sent in packets comprising a header and a payload, where no training sequence/pilot symbols are available for parameter estimation.

In order for a digital communication system to work properly, some kind of frequency estimation and timing recovery have to be performed. In addition, channel equalization can be used if the time delay spread of the channel is large relative to the duration of a symbol.

To facilitate the frequency estimation, the timing recovery, and the channel equalization, a number of known symbols can be sent, sometimes referred to as pilot symbols or training sequences. However, this method of data transmission reduces the throughput because a part of the transmitted symbols does not contain user data.

FIG. 1 shows a block diagram of a signal that includes a training sequence 100. The signal also contains a frame synchronization word 102, a header 110 and a payload 120. Although the training sequence 100 is shown at the start of the signal, it may be located at other positions within the signal, such as the center of the signal. Additionally, the locations of the frame synchronization word 102, header 110 and payload 120 are not restricted to the specific locations shown. Knowledge of the training sequence 100 facilitates the receiver's estimation of the above-described parameters. The frame synchronization word 102 is typically significantly shorter (e.g., 16 binary symbols) than both the header 110 (e.g., 96 binary symbols) and the training sequence 100. The frame synchronization word 102 is detected during signal reception to facilitate locating the first symbol of the header 110. Although the frame synchronization word 102 contains known symbols, the number of symbols is insufficient for time and frequency estimation in a data-aided manner.

Alternatively, the frequency estimation and the symbol synchronization can be performed on the data directly. Thus, no symbols are wasted because pilot symbols are not used (i.e., the frequency spectrum is more effectively used). FIG. 2 shows a block diagram of a signal that does not include a training sequence or pilot symbols. The signal contains a frame synchronization word 202, a header 210 and a payload 220. As noted above, the locations of the frame synchronization word 202, header 210 and payload 220 are not restricted to the specific locations shown. However, if no pilot symbols are used, then the estimation typically will be worse than estimation that uses pilot symbols. Therefore, the system performance in terms of bit or packet error rate will be worse. Once again, the number of symbols in the frame synchronization word 202 is insufficient for time and frequency estimation in a data-aided manner.

In digital communication systems in general, and in wireless communication systems in particular, data is often sent in a packet having a frame synchronization word, a header and a payload. The header contains vital information for the link, such as control signals, the length of the packet and the like. If the header is not received correctly, the entire packet is disregarded and a retransmission of the entire packet is requested. The payload contains the actual user information to be transmitted. If the payload is received in error, a retransmission of that particular payload is requested. However, if the header is correct, the information in the header may be used regardless of errors in the payload. Therefore, an incorrect header is worse than an incorrect payload. Thus, the header is typically better protected, either by using a more powerful Forward Error Correction (FEC) code, or by employing a more robust modulation format. For example, in a BLUETOOTH™ wireless system, the header is always protected by a (3,1) repetition code, whereas the payload might not be coded.

Since the header is more robust, the accuracy requirement for estimating parameters of the header is typically not as severe as it is for the payload. Therefore, the header is likely to be correctly demodulated even though parameters, such as frequency offset, timing, and the like, are only coarsely estimated. If pilot symbols are not used, then the header symbols can be used for performing the estimation. Typically, the estimation can be performed by two standard techniques. The estimation can be performed either by using non-data aided (NDA) estimation or by using decision directed (DD) estimation. If the header is correctly demodulated, it can be used in a DD manner to estimate the channel. Using the channel estimate, the coefficients in the equalizer can easily be calculated.

If a linear receiver is employed, it does not matter that the modulation formats of the header (which is used to calculate the equalizer) and the payload (where the equalizer is used) are different. However, if a limiting receiver is used, this is no longer the case. For example, assume phase shift keying (PSK) is used. In PSK, the transmitted symbols can be thought of as points on the unit circle, where the information is contained in the phase. More precisely, if M-ary PSK is used then the lth symbol, sₗ, can be written

sₗ=e^{i2πm/M}, Mε(0,1, . . . ,M−1), (1)

where M, for example, is 2, 4, or 8, and m is the relative phase position of the lth symbol. FIG. 3A shows the signal format for M=2, or binary PSK (BPSK). FIG. 3B shows the signal format for M=4, or quaternary PSK (QPSK). FIG. 3C shows the signal format for M=8, or 8PSK.

Furthermore, assume BPSK, is used for the header, and QPSK is used for the payload. Then there are only two possibilities regarding two consecutive symbols for BPSK (i.e., either the symbols are the same or they are different). Referring to equation (1), this can also be viewed as either the phase remains the same (0 or π), or there is a phase shift of π. Therefore, the equalizer can be designed to handle phase shifts of 0 and π, since these are the only possibilities during the header. However, since the payload is sent using QPSK, in addition to those phase shifts obtained for the header, two more possibilities exist, namely ±π/2. As a result, since all possible phase shifts are needed in the training sequence, the training sequence should have the same modulation format as the payload. This is highly undesirable since the header is used as the training sequence and the header typically should be much more robust than the payload.

Therefore, a method and apparatus are needed that can provide accurate parameter estimation in a limiting receiver without using pilot symbols in the transmitted signal and where the header and the payload have different modulation formats.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

The invention provides a method and apparatus for parameter estimation comprising performing a first estimation of a first portion of a signal to obtain first parameters of the first portion of the signal. The first portion of the signal has predetermined offsets added to the first portion during transmission and the predetermined offsets are based on a modulation format of a second portion. The first and second portions have different modulation formats. The first portion of the signal is demodulated using the first parameters to recover data symbols. The equalizer coefficients are estimated using the first portion of the signal in a DD manner. The demodulated first portion of the signal is checked to confirm correct demodulation of the first portion of the signal. If the first portion of the signal is correctly demodulated, a second portion of the signal is demodulated using the equalizer coefficients.

The invention also provides for a method of transmitting a signal. The method comprises dividing a first portion of the signal into a plurality of segments. A distinct phase shift is added to each segment of the first portion of the signal. Then, the signal containing the phase shifted first portion is transmitted.

Further, the invention provides for a method of receiving a signal. The method comprises receiving and converting the signal into a digital format. The signal contains a first portion that has been phase shifted by adding N distinct phase shifts to a plurality of segments of the first portion, wherein N is an integer greater than or equal to one. The first portion is multiplied with a conjugated delayed version of the first portion, wherein the delay equals N symbols. In the case of NDA estimation, the result of the multiplication is then squared. When DD estimation is employed, a decision regarding the received bit is made.

The above features and advantages of the invention will be more apparent and additional features and advantages of the invention will be appreciated from the following detailed description of the invention made with reference to the drawings.

### BRIEF DESCRIPTION OF THE DRAWINGS

The invention will now be described with reference to the following figures, in which:

FIG. 1 illustrates a data packet that includes a training sequence;

FIG. 2 illustrates a data packet that does not include a training sequence or pilot symbols;

FIGS. 3A-C illustrate the data constellation for BPSK, QPSK, and 8PSK, respectively;

FIG. 4 is a block diagram illustrating an exemplary apparatus of the invention when NDA estimation is used;

FIG. 5 is a block diagram illustrating another exemplary embodiment of the apparatus of FIG. 4 when NDA estimation is used;

FIG. 6 is a flowchart illustrating an exemplary method of the invention when NDA estimation is used;

FIG. 7 is a block diagram illustrating a further exemplary embodiment of the invention when NDA estimation is used;

FIG. 8 is a flowchart illustrating a signal transmission method of the invention; and

FIG. 9 is a flowchart illustrating a signal reception method of the invention when NDA estimation is used.

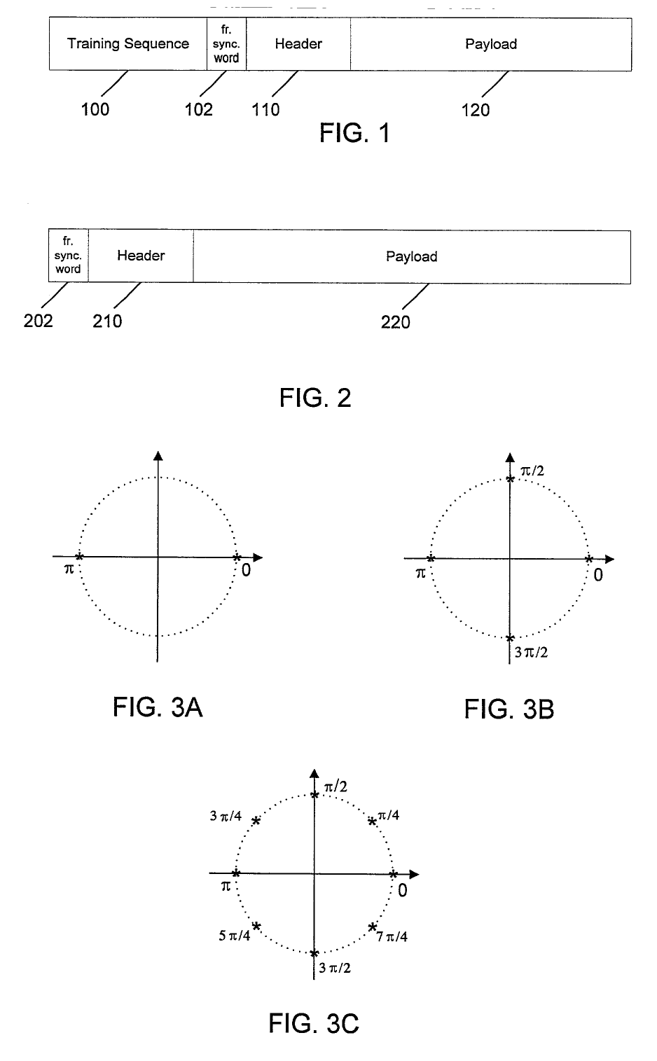

### DETAILED DESCRIPTION

In the following description, for purposes of explanation and not limitation, specific details are set forth, such as particular circuits, circuit components, techniques, and the like in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the present invention. Before describing specific embodiments of the invention a brief overview of the invention is provided.

The invention will be described in connection with a number of exemplary embodiments. To facilitate an understanding of the invention, many aspects of the invention are described in terms of sequences of actions to be performed by elements of a computer-based system. It will be recognized that in each of the embodiments, the various actions could be performed by specialized circuits (e.g., discrete logic gates interconnected to perform a specialized function), by program instructions being executed by one or more processors, or by a combination of both.

Moreover, the invention can additionally be considered to be embodied entirely within any form of a computer readable storage medium having stored therein an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of an embodiment may be referred to herein as “logic configured to” perform a described action, or alternatively as “logic that” performs a described action.

In the following description, the frame synchronization word will not be addressed. As previously noted, the frame synchronization word is used only to establish the necessary start position to decode the header and is not sufficient for data aided estimation. Once the frame synchronization is obtained, the header can be checked for errors by the code used for error detection in a conventional manner.

The invention provides methods and apparatuses that perform equalization when a limiting receiver is used. Further, training sequences are not used in the transmitted signal but instead the robustly modulated header is used. Although it uses a different modulation format than the payload, the header is designed to contain the characteristic features of higher order modulation formats. Therefore, the header can be used to find the equalizer coefficients for the payload, when a nonlinear receiver is employed.

Assume that data is transmitted in packets which consist of a header and a payload. Also, assume that M-ary PSK is the modulation used and that the header is binary modulated (i.e., M=2), whereas the payload is transmitted using 2, 4, or 8-ary PSK. This means that the header is considerably more robust than the payload when QPSK or 8PSK is used for the payload. Furthermore, assume that the header is coded for error detection, in order to minimize the chance that an incorrect header is accepted. Finally, assume that no training symbols are included in the header or in the payload for performing parameter estimation, such as frequency estimation and timing recovery. Therefore, data aided estimation cannot be employed directly because there are no known symbols available.

In a first estimation, NDA estimation is used for a robustly modulated/coded first portion of the packet. Typically, the first portion used for the first estimation is the header of the data packet. The estimated parameters from the header are used to demodulate the corresponding data symbols in the first portion. The header includes coding for error detection that makes it possible to determine if the demodulation was successful. If the demodulation was successful, then the corresponding data symbols are assumed to be correct.

Additionally, an equalizer can be trained in a DD manner at the same time that the header is demodulated. The symbols in the header are used as if they were correct to train the equalizer. As the header is checked for errors by the error detecting code, one will eventually know if all symbols are correct. If the header is correct, this means that the equalizer has in fact been trained as effectively as if the data had been known.

Note that this can be viewed as iterative parameter estimation, where a first set of parameters, in this case time and frequency offset, are estimated in the first estimation. Then, in the second round of parameter estimation the equalizer coefficients are estimated. In this particular case, the second parameter estimation is performed at the same time that the header is demodulated. This way of performing parameter estimation is described in “Method and apparatus for iterative parameter estimation” U.S. application Ser. No. 09/828,228, filed on Apr. 9, 2001, which is hereby incorporated by reference in its entirety.

For a linear receiver, the equalizer can be trained using a modulation format that is different from the payload. For example, a binary PSK header can be used to train an equalizer that is used for a QPSK or 8-PSK payload. However, for a limiting receiver, it is not possible to train the equalizer using this method because all possible transitions between two consecutive symbols are not present in the header. To avoid this problem, the following header transmission method is used.

For example, assume that the received signal (e.g., a packet) has a binary header, which in general consists of n symbols, where n=96. The first 24 symbols in the header are transmitted without adding any extra phase shift between the symbols (i.e., the phase shift between two consecutive symbols is either 0 or π, see equation (1) where M=2). During the next 24 symbols, a phase shift of π/4 is added for each symbol. This means that the phase shift between two symbols is either π/4 or 5π/4=−3π/4. For the following 24 symbols, a phase shift of π/2 is added, meaning that the phase shift between two consecutive symbols is either π/2 or 3π/2. Finally, during the last 24 symbols in the header, a phase shift of 3π/4 is added so that the possible phase shifts between two symbols are either 3π/4 or 7π/4. Using this transmission method, there is a very high probability that all possible phase shifts have been generated, although the header is binary and does not contain a specific training sequence.

In Table 1, the added phase shifts and the resulting possible phase shifts are summarized.

TABLE 1

| Added phase shift | Resulting phase shifts |
|---|---|
| 0 | 0, π |
| π/4 | π/4, 5π/4 |
| π/2 | π/2, 3π/2 |
| 3π/4 | 3π/4, 7π/4 |

Those skilled in the art will appreciate that adding extra phase shifts to the header does not imply any problem at the transmitter side. However, the additional phase shifts must also be addressed at the receiver side of the system.

First, consider the actual demodulation of the binary symbols in the header. A distinction may be made between the case where frame synchronization is obtained prior to the parameter estimation, and the case where frame synchronization is obtained after parameter estimation is completed.

Obtaining frame synchronization prior to performing parameter estimation offers the advantage of being able to accommodate greater time uncertainty in the received symbol stream. When using this approach, the added phase shifts should be subtracted from the respective symbols to avoid affecting the parameter estimation process. Once the added phase shifts are removed, any conventional algorithm for performing the desired parameter estimation may be used.

In the case where parameter estimation is performed prior to achieving frame synchronization, care must be taken to ensure that the added phase shifts, whatever their values may be, do not detrimentally affect the parameter estimation process itself.

Before explaining the invention further, properties for performing frequency offset estimation when the modulation is M-PSK are introduced. For example, if the received signal is raised to the Mth power, the modulation is removed. This is easily seen since

sₗ=(e^{i2πm/M})^{M}=e^{i2πm}=1^{m}, mε(0,1, . . . , M−1). (2)

Furthermore, if there is a frequency offset, this implies that the phase is changing from one received symbol to the next. Therefore, if the phase change can be estimated, then the corresponding frequency offset can be calculated. Examples of receiving a signal with and without a frequency offset are provided below.

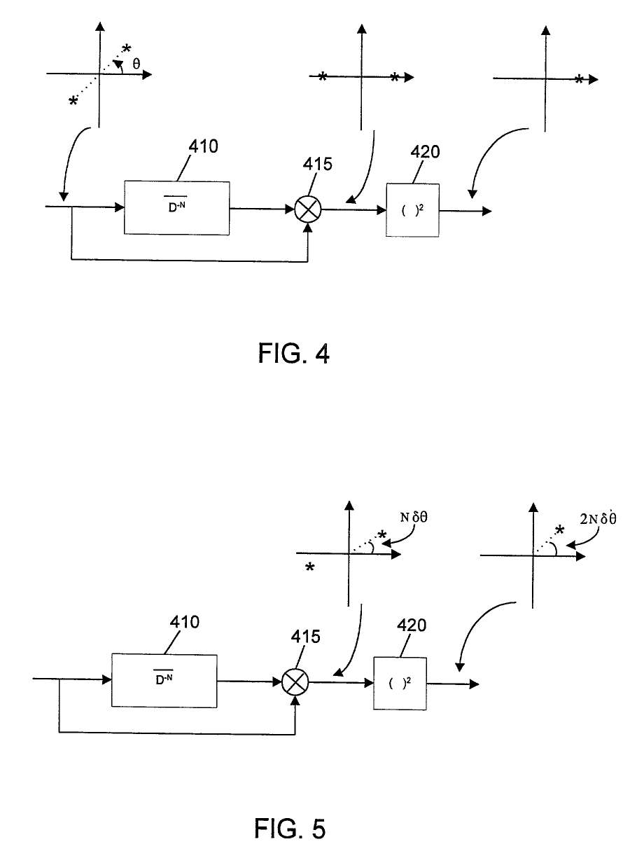

Referring to FIG. 4, a received signal is shown having no frequency offset in the received signal. At the left-hand side in this figure, the received signal is either exp (jθ) or exp (jθ+π), where θ is an arbitrary phase shift introduced by the channel. The received signal is fed to block 410 that delays and conjugates the signal, where the delay is N symbols. Then the signal is multiplied with the conjugate of a delayed version of itself by multiplier 415. Assume θ1 and θ2 denote the direct and the delayed signal, respectively, then the result of this multiplication is exp (jφ)=exp(jθ1 )exp(−jθ2 )=exp j(θ1−θ2 ). The arbitrary phase θ is removed and in fact φ=0 or φ=π. Then the signal is fed to block 420, where the signal is squared. Referring to equation (1), it follows that the result is exp(jφ)=exp(j0)=1.

In FIG. 5, a frequency error of δf Hz is introduced. In this case the arbitrary phase θ is not constant, but is time varying. If the symbol duration time is Tₛ, then θ will change δθ=2πδfTₛ radians per symbol. Once again, the received signal is fed to block 410 that delays and conjugates the signal, where the delay is N symbols. Then the signal is multiplied with the conjugate of a delayed version of itself by multiplier 415. The output of multiplier 415 yields φ=0+Nδθ or φ=π+Nδθ. This signal is fed to block 420, where the signal is squared. In this case when the signal is squared, the result is exp(j2Nδθ).

For notational convenience, the phase 2Nδθ is denoted by θₜₒₜ. In considering θₜₒₜ, if there is an extra phase rotation added between transmitted symbols, this can affect θₜₒₜ. Again, if this phase shift is known, there is no problem because the known phase shift can simply be subtracted. However, it is also possible to perform frequency estimation although this phase shift is not known. Assume the only known information regarding the phase shift is that it is one of the possibilities listed in Table 1 (i.e., 0, π/4, π/2, or 3π/4). In fact, from the discussion above, it is clear that if we denote the added phase by θₐ, then its effect on the estimated frequency will be identically zero provided 2Nθₐ a is a multiple of 2π. For example, this means that N=4 is the smallest integer such that

2Nθₐ=k2π, k=0,1,2, . . . , (3)

where θₐε{0, π/4, π/2, or 3π/4}. Those skilled in the art will appreciate that the invention is not limited to the above example.

The relationship defined in equation (3) is not valid unless the values of θₐ assigned to all symbols included in the delayed version of the received signal are the same. For example, consider again the above-described example in which a header of 96 bits is divided into four segments of 24 bits each, and where a four symbol long delay line (i.e., N=4) is used to produce the required delayed version of the receive signal. In such an arrangement, when a bit, say bit number 26, is being received, the corresponding bit received four bit times earlier, i.e., bit number 22, will be present at the output of the delay line.

Applying the added shift values from Table 1, the added phase shift between bit numbers 22 and 23, as well as between bit numbers 23 and 24, will be zero. Similarly, the added phase shift between bit numbers 24 and 25, as well as between bit numbers 25 and 26, will be π/4. Thus, the total added shift will be equal to π/2(2*0+2*π/4) , which when squared, is equal to π rather than a integer multiple of 2πas predicted by equation (3).

In a system where frame synchronization is performed prior to parameter estimation, the added phase shift may be calculated in a straight-forward manner and then subtracted from the received symbols prior to performing frequency estimation. For example, Table 2 shows a portion of the header of the above-described example where the added phase shift changes from 0 to π/4.

TABLE 2

| Received Symbol # | Delayed Symbol # | Added Phase | After Squaring |
|---|---|---|---|
| 23 | 19 | 0 | 0 |
| 24 | 20 | 0 | 0 |
| 25 | 21 | π/4 | π/2 |
| 26 | 22 | π/2 | π |
| 27 | 23 | 3π/4 | 3π/2 |
| 28 | 24 | π | 2π = 0 |
| 29 | 25 | π | 2π = 0 |

In a system where frame synchronization is performed after parameter estimation it is not known which symbols are affected by the added phase shifts, and thus it is possible to pre-compensate for these added phase shifts. Two observations may be made from the phase information summarized in Table 2, however. First, each time the added phase shift changes value, a maximum of three symbols will assigned added phase values that will affect the parameter estimation process (i.e., non-zero phase values). Second, of these three affected symbols, the added phase shifts cancel in the following manner. One of the affected symbols will have an assigned phase of −π/2, while another of the affected symbols will have an assigned phase of −π/2(or 3π/2), which when combined will cancel one another out. The final affected symbol will have an assigned phase value of π, corresponding to a phase that is opposite in direction, but nevertheless proper in angle, to the correct symbol phase. This will merely result in a reduction in magnitude during the parameter estimation process.

Up to this point, only the frequency offset estimation has been considered. Regarding the time estimation (i.e., finding the optimum sampling time) it will also be independent of the added phase when the timing is found after the effect of the added phase has been removed as described above. Therefore, those skilled in the art will appreciate that any known technique for performing time estimation can be used. For example, the time estimation can be performed by oversampling the incoming signal (e.g., 16 times oversampling). Then, one sample out of these possible 16 that gives the best result according to conventional timing estimation techniques would be used.

The equalization process is well known in the art and may be performed using known techniques. There exist three basic classes of equalizers: (1) linear equalizers, (2) decision-feedback equalizers (DFEs), and (3) maximum-likelihood sequence estimation (MLSE) equalizers. Of these three classes of equalizers, the linear equalizer is not well-suited for use with the methods and apparatuses described herein, as a result of the non-linear nature of the problem being addressed. Among these classes of equalizers, the MLSE equalizer is preferred. With such equalizers, the effect the varying added phase shifts have on the limiter may be easily invoked in the calculation of the equalizer metrics. More detailed descriptions of such known equalization techniques may be found in standard textbooks such as J. G. Proakis, Digital Communications, 2nd ed. New York: McGraw-Hill, 1989.

It will be understood by those skilled in the art that these standard equalization processes can be employed because the signal has already been processed to provide both the training symbols (i.e., the correctly decoded header symbols), and all possible phase shifts needed in the training sequence (e.g., by adding the predetermined phase shifts of Table 1 to the header).

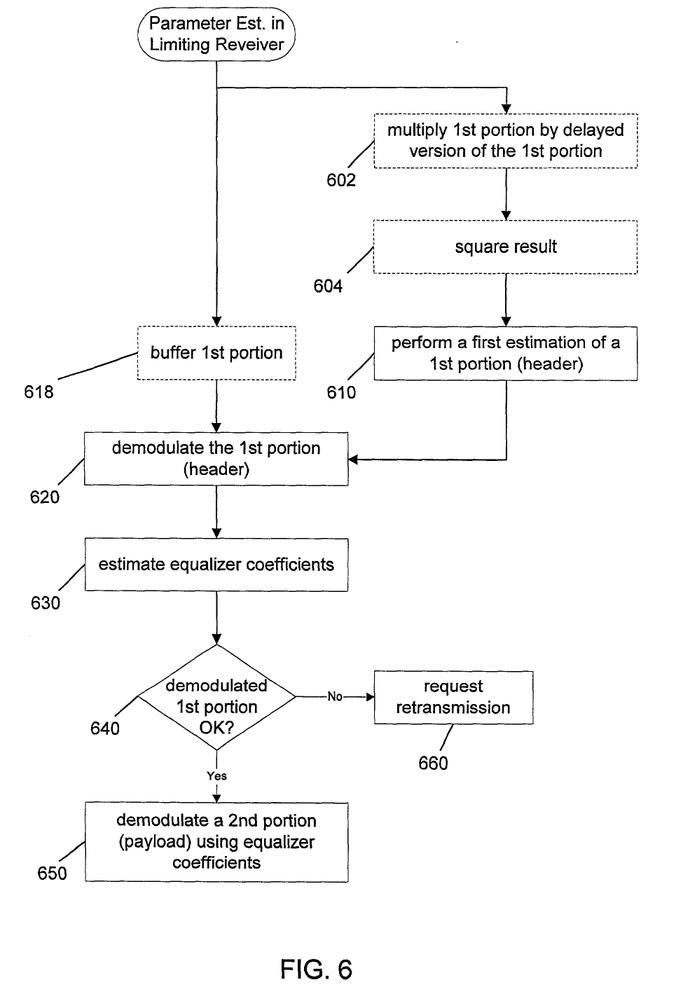

FIG. 6 shows an exemplary method of parameter estimation in a limiting receiver. The process starts in step 610 by performing a first estimation of a first portion (e.g., the header) of a signal to obtain first parameters (e.g., frequency offset, optimum sampling time, and the like) of the first portion of the signal. In the case of frequency estimation, the step 610 typically involves performing a parameter summation over a suitable number of header symbols. Referring once again to the above-described example in which a header of 96 bits or symbols is used, a portion of the header, say 84 symbols, may be used to perform the estimate.

It may be advantageous to use less than all of the available symbols (e.g., 96 symbols) to perform the estimate when frame synchronization has not yet been achieved, as time uncertainty in the message framing should be accounted for. By not using the first and last parts of the header to perform the estimation, one can ensure that parameter estimation is being performed on the header rather than some other portion of the received message. For example, if one knows that the time uncertainty in the framing does not exceed four symbols, one could start filling a N=4 delay line with symbols upon receipt of the fifth symbol. Then the first difference calculation may be performed upon receipt of the ninth symbol. Similarly, one might choose to discard the last four symbols of the header when performing the desired parameter estimation with such an arrangement.

The first portion of the signal has predetermined offsets added to the first portion during transmission. For example, the offsets can be phase shifts (e.g., 0, π/4, π/2 and 3π/4) as described above. These offsets are based on the modulation format of the second portion (e.g., 8PSK), where the first and second portions have different modulation formats. For example, the first portion can be divided into four segments, where 0 is added to a first segment, π/4 is added to a second segment, π/2 is added to a third segment, and 3π/4 is added to a fourth segment.

Also, as described above, the first estimation is performed in a manner such that the added phase shift has no effect on the outcome of the parameter estimation. Optionally, this can be accomplished by multiplying the first portion with a conjugated delayed version of the first portion, in step 602. The delay can be N symbols, wherein N is a number of distinct offsets (e.g., N=4 phase shifts added) to the first portion. In the case of NDA estimation, the result of the multiplication is then squared in step 604 prior to performing the first estimation. Also, the signal (or the first portion of the signal) can optionally be buffered until needed after the first estimation is completed, in step 618. In step 620, the first portion of the signal is demodulated using the first parameters from the first estimation to recover data symbols. In step 630, the equalizer coefficients are estimated in a DD manner using the first portion of the signal. However, those skilled in the art will appreciate that the demodulation and training of the equalizer can be performed simultaneously. In step 640, the demodulated first portion of the signal is checked to confirm correct demodulation of the first portion of the signal. If the first portion of the signal is correctly demodulated, then a second portion (e.g., payload) of the signal is demodulating using the equalizer coefficients, in step 650. However, if the portion of the signal is not correctly demodulated, then a retransmission of the entire signal can be requested, in step 660.

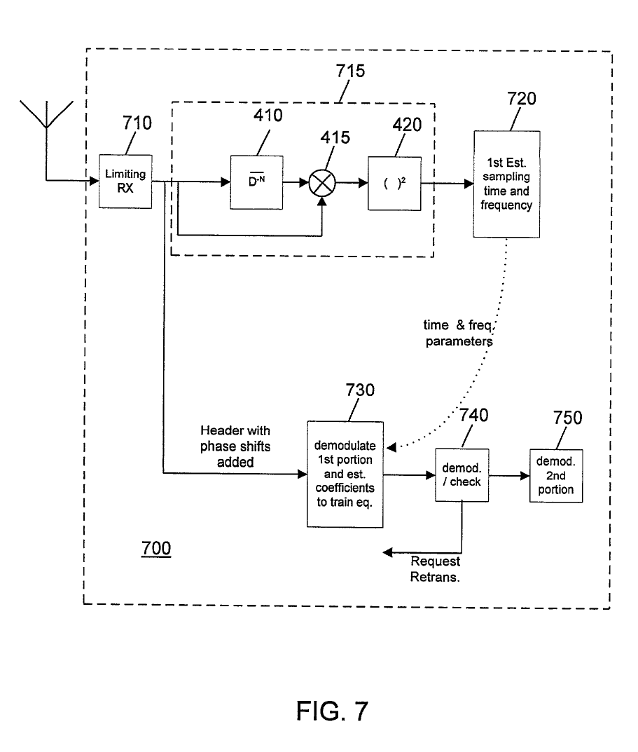

FIG. 7 illustrates an apparatus 700 that performs parameter estimation in a limiting receiver. The apparatus may be a receiver, as illustrated, having a receiving circuit 710 that receives and converts a transmitted signal to a signal that may be further processed (e.g., the signal in a digital format) as is well known in the art. The signal generated by the receiving circuit 710 is provided to block 720 that contains logic that performs a first estimation of a first portion of the signal to obtain first parameters of the first portion of the signal. The signal need not contain any known data symbols. The first portion of the signal contains predetermined offsets that were added to the first portion during transmission. The offsets are based on the modulation format of the second portion. Additionally, the first and second portions have different modulation formats.

The first estimation 720 is performed in a manner such that the added offsets have no effect on the outcome of the parameter estimation. This can be accomplished, for example, by first feeding the signal from receiving circuit 710 to block 715. Block 715 contains logic that multiplies the first portion with a conjugated delayed version of the first portion and logic that squares the result of the multiplication, prior to performing the first estimation.

Those skilled in the art will appreciate that a buffer could be inserted before block 730 to store the signal (or at least the first portion of the signal) until the first parameters are estimated or the signal could be provided from a buffered memory in the receiving circuit 710 as shown.

Regardless of the buffering process, the first parameters and the signal are provided to block 730 that comprises logic that demodulates the first portion of the signal using the first parameters to recover data symbols. Additionally, block 730 contains logic that estimates equalizer coefficients using the first portion of the signal in a DD manner. The processed information is then passed to block 740. Block 740 includes logic that checks the demodulated first portion of the signal to confirm correct demodulation of the first portion of the signal. Block 740 can also contain logic that requests a retransmission of the signal, if the first portion is not demodulated correctly.

One skilled in the art will appreciate that retransmission request techniques are well known in the art and will not be described herein. If the first portion of the signal is correctly demodulated, the equalizer coefficients and the signal are provided to block 750. Block 750 contains logic that demodulates a second portion of the signal using the equalizer coefficients.

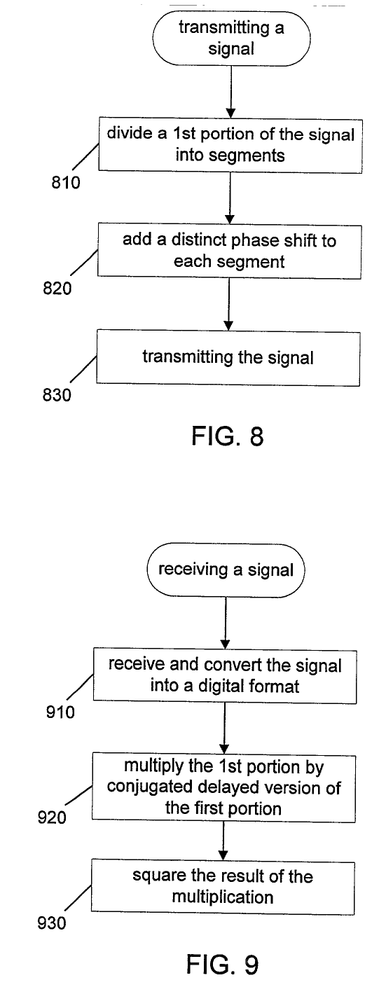

FIG. 8 illustrates a method of transmitting a signal. The process starts by dividing a first portion of the signal into a plurality of segments, in step 810. In step 820, a distinct phase shift is added to each segment of the first portion of the signal based on the modulation format of a second portion. Then, the signal containing the phase shifted first portion is transmitted, in step 830.

FIG. 9 illustrates a method of receiving a signal. The process starts by receiving and converting the signal into a digital format, wherein the signal contains a first portion that has been phase shifted by adding N distinct phase shifts to a plurality of segments of the first portion, wherein N is an integer greater than or equal to one, in step 910. In step 920, the first portion is multiplied with a conjugated delayed version of the first portion wherein the delay is N symbols. Then, in step 930, the result of the multiplication is squared, thereby removing the effect of the added phase shifts from the first portion.

The foregoing has described the principles, preferred embodiments and modes of operation of the invention. However, the invention should not be construed as being limited to the particular embodiments discussed above. For example, the invention is not limited to particular methods or sequences for performing the first estimation and equalizer coefficient estimation. For instance, NDA estimation of several parameters may be performed in parallel, in series, or jointly. Similarly, the data-aided estimation of several parameters may be performed in parallel, in series, or jointly. Also, any method for the first estimation and equalizer coefficient estimation may be used provided the first estimation method is not data aided and the equalizer coefficient estimation method is data aided.

Additionally, the above examples have used PSK in describing the invention. However, those skilled in the art will recognize that the invention can be practiced with other modulation formats that are suitable for use with a limiting receiver, such as Frequency Shift Keying (FSK) and the like.

Therefore, the above-described embodiments should be regarded as illustrative rather than restrictive, and it should be appreciated that variations may be made in those embodiments by workers skilled in the art without departing from the scope of the invention as defined by the following claims.

What is claimed is:

1. A method of parameter estimation in a limiting receiver comprising:
performing a first estimation of a first portion of a signal to obtain first parameters of the first portion of the signal, wherein the first portion of the signal has predetermined offsets added during transmission and the predetermined offsets are based on a modulation format of a second portion, and wherein the first and second portion have different modulation formats;
demodulating the first portion of the signal using the first parameters to recover data symbols;
estimating equalizer coefficients using the first portion of the signal in a decision directed manner;
checking the demodulated first portion of the signal to confirm correct demodulation of the first portion of signal; and
demodulating the second portion of the signal using the equalizer coefficients when the first portion of the signal is correctly demodulated.

2. The method of claim 1, wherein the offsets are phase shifts and wherein the phase shifts added are at least one of 0, π/4, π/2, and 3π/4.

3. The method of claim 2, wherein the first portion is divided into four segments and wherein 0 is added to a first segment, π/4 is added to a second segment, π/2 is added to a third segment, and 3π/4 is added to a fourth segment.

4. The method of claim 2, wherein the first portion is divided into two segments and wherein 0 is added to a first segment, and π/2 is added to a second segment.

5. The method of claim 1, wherein the first portion is a header of the signal.

6. The method of claim 1, wherein the first portion of the signal is encoded for error correction.

7. The method of claim 1, wherein the second portion is encoded for error detection.

8. The method of claim 1, wherein the signal is a signal in accordance with Bluetooth wireless technology.

9. The method of claim 1, wherein the first estimation is performed using non-data aided or decision directed techniques.

10. The method of claim 1, wherein the first portion of the signal is binary Phase Shift Keying modulated and wherein the second portion is M-ary Phase Shift Keying modulated, wherein M is greater than or equal to 4.

11. The method of claim 1 further comprising:
requesting a retransmission of the signal, if the first portion is not demodulated correctly.

12. The method in claim 1, wherein the first parameters are at least one of a frequency offset and an optimum sampling time.

13. The method of claim 1, wherein demodulating of the first portion and training the equalizer are performed simultaneously.

14. The method of claim 1, further comprising:
multiplying the first portion with a conjugated delayed version of the first portion; and
squaring the result of the multiplication, prior to performing the first estimation.

15. The method of claim 14, wherein the delay is N symbols, wherein N is a number of distinct offsets added to the first portion.

16. The method of claim 14, wherein the delay is N symbols, wherein N is chosen such that:
2Nθₐ−2π,
where θₐ represents the predetermined offsets added to the first portion.

17. An apparatus for parameter estimation in a limiting receiver comprising:
logic that performs a first estimation of a first portion of a signal to obtain first parameters of the first portion of the signal, wherein the first portion of the signal has predetermined offsets added to the first portion during transmission and the predetermined offsets are based on a modulation format of a second portion, and wherein the first and second portion have different modulation formats;
logic that demodulates the first portion of the signal using the first parameters to recover data symbols;
logic that estimates equalizer coefficients using the first portion of the signal in a decision directed manner;
logic that checks the demodulated first portion of the signal to confirm correct demodulation of the first portion of signal; and
logic that demodulates a second portion of the signal using the equalizer coefficients when the first portion of the signal is correctly demodulated.

18. The apparatus of claim 17, wherein the offsets are phase shifts and wherein the phase shifts added are at least one of 0, π/4, π/2, and 3π/4.

19. The apparatus of claim 18, wherein the first portion is divided into four segments and wherein 0 is added to a first segment, π/4 is added to a second segment, π/2 is added to a third segment, and 3π/4 is added to a fourth segment.

20. The apparatus of claim 18, wherein the first portion is divided into two segments and wherein 0 is added to a first segment, and π/2 is added to a second segment.

21. The apparatus of claim 17, wherein the first portion is a header of the signal.

22. The apparatus of claim 17, wherein the first portion of the signal is encoded for error correction.

23. The apparatus of claim 17, wherein the second portion is encoded for error detection.

24. The apparatus of claim 17, wherein the signal is a signal in accordance with Bluetooth wireless technology.

25. The apparatus of claim 17, wherein the first estimation is performed using non-data aided or decision directed techniques.

26. The apparatus of claim 17, wherein the first portion of the signal is binary Phase Shift Keying modulated and wherein the second portion is M-ary Phase Shift Keying modulated, wherein M greater than or equal to 4.

27. The apparatus of claim 17, further comprising:
logic that requests a retransmission of the signal, if the first portion is not demodulated correctly.

28. The apparatus of claim 17, wherein the first parameters is at least one of a frequency offset and an optimum sampling time.

29. The apparatus of claim 17, wherein demodulating of the first portion and training the equalizer are performed simultaneously.

30. The apparatus of claim 17, further comprising:
logic that multiplies the first portion with a conjugated delayed version of the first portion; and
logic that squares the result of the multiplication, prior to performing the first estimation.

31. The apparatus of claim 30, wherein the delay is N symbols, wherein N is a number of distinct offsets added to the first portion.

32. The apparatus of claim 30, wherein the delay is N symbols, wherein N is chosen such that:
2Nθₐ=2π,
where θₐ represents the predetermined offsets added to the first portion.

33. A method for transmitting a signal comprising:
dividing a first portion of the signal into a plurality of segments;
adding a distinct phase shift to each segment of the first portion of the signal, wherein the distinct phase shift that is added to each segment is based on the modulation format of a second portion; and
transmitting the signal containing the phase shifted first portion.

34. A method for receiving a signal comprising:
receiving the signal;
converting the signal into a digital format, wherein the signal contains a first portion that has been phase shifted by adding N distinct phase shifts to a plurality of segments of the first portion, wherein N is an integer greater than 1;
multiplying the first portion with a conjugated delayed version of the first portion, wherein the delay is N symbols; and
squaring the result of the multiplication, thereby removing the effect of the added phase shifts from the first portion.
